(19) United States
(12) Patent Application Publication
(10) Pub. No.: US 2013/0017341 A1
(43) Pub. Date: Jan. 17, 2013

(54) Method for Forming Gas Sensing Layers

(71) Applicants: Nicolas Boscher, Audun le Tiche (FR); Patrick Choquet, Longeville les Metz (FR); David Duday, Luxembourg (LU)

(72) Inventors: Nicolas Boscher, Audun le Tiche (FR); Patrick Choquet, Longeville les Metz (FR); David Duday, Luxembourg (LU)

(73) Assignee: CENTRE DE RECHERCHE PUBLIC - GABRIEL LIPPMANN, Belvaux (LU)

(21) Appl. No.: 13/542,754

(22) Filed: Jul. 6, 2012

(30) Foreign Application Priority Data
Jul. 15, 2011 (LU) 91841

(51) Int. Cl. B05D 3/04

(52) U.S. Cl. 427/489; 427/488

(57) ABSTRACT

The present disclosure provides a method for forming a porous colorimetric gas sensing layer. In various embodiments, the method comprises providing a mixture of an organic solvent, a polymer forming material and a gas sensing compound or gas sensing particles. The method additionally comprises depositing the mixture (sprayed or vaporized) on at least a surface portion of a substrate. Thereafter, an atmospheric pressure plasma is applied to the surface portion to form a polymer layer comprising the gas sensing compound or particles. The steps of depositing the mixture and applying the plasma can be repeated multiple times to form a plurality of stacked or superposed polymer layers comprising the gas sensing compound or particles.

### CROSS-REFERENCE TO RELATED APPLICATIONS

This application claims the benefit, under 35 U.S.C. §119, of LU 91841, filed Jul. 15, 2011, the disclosure of which is incorporated herein by reference in its entirety.

### FIELD

The present teachings relate to a method for providing colorimetric gas sensing layers, wherein gas sensing molecules or particles are embedded in a polymer matrix

### BACKGROUND

The statements in this section merely provide background information related to the present disclosure and cannot constitute prior art.

Document WO 2007/075443 A1 discloses a plasma deposited microporous analyte detection layer and a method for producing such a layer. The layer can be obtained by forming a plasma from a gas mixture comprising an organosilane, oxygen and a hydrocarbon. The plasma is deposited on a substrate to form an amorphous random covalent network layer. This amorphous network layer is heated to finally form a microporous amorphous random covalent network layer.

Several of such plasma deposition methods are known in the state of the art using polymer forming precursors injected directly into a plasma discharge and used to deposit different types of films on surfaces.

However, in the production of smart optically active surfaces, such methods have the disadvantage that optically active particles, especially gas sensing molecules, are often damaged during the application process or poorly dispersed in the matrix material. The deposited substances might lose their functionality or might even be destroyed making them useless for their purpose, as for instance for gas sensing.

In view of the above mentioned disadvantages, it would be advantageous to provide a method for producing smart optically active surfaces, especially gas sensing surfaces, having a high sensing capability.

### SUMMARY

In various embodiments, the present disclosure provides a method for forming a porous colorimetric gas sensing layer, wherein the method comprises providing a mixture of an organic solvent, a polymer forming material and a gas sensing compound or gas sensing particles. In a further step, the mixture is deposited (sprayed or vaporized) on at least a surface portion of a substrate. Thereafter, an atmospheric pressure plasma is applied to the surface portion to form a polymer layer comprising the gas sensing compound or particles. Finally, the steps of depositing the mixture and applying the plasma can be repeated multiple times to form a plurality of stacked or superposed polymer layers comprising the gas sensing compound or particles.

According to the present disclosure, the crystallinity and/or functionality of the deposited sensitive gas sensing molecules, particles or compounds can be preserved. It is decisive for the present disclosure that the mixture is first deposited on the surface of the substrate and that an atmospheric pressure plasma is applied thereafter. This procedure protects the very sensitive gas sensing molecules. By spraying the mixture directly on the substrate, rather than spraying it in the discharge, the gas sensing molecules are covered by the polymer formed during the plasma treatment, so that these are protected at an early stage. Furthermore, the present disclosure allows for obtaining a porous layer which enables gases or volatiles to come in contact with the gas sensing elements. The presence of an organic solvent allows dispersing of the gas sensing molecules in the layers and favors the formation of porosity while evaporating. Moreover, the use of the atmospheric pressure plasma allows for a simple and fast production of such sensing layers. In particular, no vacuum, as used in low pressure techniques, is generated and no high temperatures are used which might lead to a damage or agglomeration of the gas sensing molecules and reduce the pore growth rate of the membrane. In particular, low pressure techniques induce a fast evaporation of both the solvent and the polymer matrix precursor resulting in the loss or severe alteration of gas sensing properties of the gas sensing molecules. Moreover, coatings formed by low pressure techniques are denser and restrict the permeation of volatile compounds through the layer, thus decreasing the gas sensing capabilities of the layer.

According to various embodiments of the present disclosure, the gas sensing compound or particles comprise one or more of pyrrole-based macrocycles, tetrapyrrols, porphyrins, metalloporphyrins, phthalocyanines, calixarenes, crystalline coordination polymers and compounds thereof. In particular, these substances or compounds of such substances have proven to result in effective gas sensing layers in combination with the method in accordance with the present disclosure. Moreover, in accordance with the present disclosure, the functionality of these particles can be preserved.

In accordance with other embodiments of the disclosure, the polymer forming material is based on organosilicon compounds. In particular, this kind of polymer forming material leads to good porosity, especially in combination with the solvents used in accordance with the present disclosure.

In accordance with yet other embodiments of the disclosure, the polymer forming material is selected from the group consisting of hexamethyldisiloxane, octamethylcyclotetrasiloxane, decamethylcyclopentasiloxane, hexaethyldisiloxane, tetraethylorthosilicate, aminopropyltrimethoxysilane, tetramethyldisiloxane, pentamethylcyclopentasiloxane, octamethylcyclooctasiloxane, polydimethylsiloxane and its derivatives. In particular, these materials could be preferably used in order to obtain an effective porous gas sensing layer.

In accordance with other embodiments of the disclosure, the organic solvent is chosen from non-polar solvents, polar aprotic solvents or polar protic solvents. For example, the organic solvent can be chosen from one or more of ethanol, methanol, isopropanol, chloroform, dichloromethane, tetrahydrofuran, aceton solvents. Moreover, the solvent can be an ethanol or a chlorine based solvent. Using these solvents results in an improved porosity of the coating, especially in combination with porphyrins or metalloporphyrins.

In accordance with other embodiments of the disclosure, the substrate at least partially consists of one or more of glass, polymers, plastics, composite materials or metals. Exemplary metals can be copper, aluminum, iron or steel.

In accordance with other embodiments of the disclosure, the step of applying the atmospheric pressure plasma is carried out, by means of a dielectric barrier discharge plasma, at a temperature of between 5° C. and 90° C., e.g., between 15° C. and 40° C. In various implementations, this narrow temperature range is utilized to carry out the method according to the present disclosure. Lower temperatures might have a negative influence on the layer formation. On the one hand, low substrate temperatures reduce the solvent evaporation rate, possibly leading to solvent retention in the deposited layer. On the other hand, higher temperatures might cause damage to the functionality of required properties of the gas sensing molecules or affect the membrane formation. Fast evaporation of the solvent, occurring for high substrate temperature, is reducing the nucleation and the pore growth rate by the rapid increase of the polymer concentration. In addition, the fast evaporation of the solvent is inducing an agglomeration of porphyrin molecules.

In accordance with other embodiments of the disclosure, the substrate is provided on a moving stage transporting the substrate through a mixture deposition zone to deposit the mixture on at least a portion of the substrate and a (downstream) plasma zone in which the atmospheric pressure plasma is applied. In other words, both zones are (spatially) distinct.

In accordance with yet other embodiments of the disclosure, the oxygen content of the dielectric barrier discharge plasma is lower than 500 ppm, e.g., below 100 ppm. In various implementatoins, the oxygen content in the plasma region is zero. The inventors discovered that low oxygen contents positively influence the gas sensing capability of the formed sensing layer. In particular, oxygen concentrations higher than 500 ppm might result in a degradation of the gas sensing molecules and prevent the formation of effective membranes.

In accordance with still other embodiments of the disclosure, depositing the mixture is performed/controlled by means of an atomizing nozzle. The use of an atomizing nozzle provides for an evenly distributed deposition of the mixture on the substrate's surface which is of advantage for the formation of a layer exhibiting a homogeneous porosity.

In accordance with yet other embodiments of the disclosure, the steps of depositing the mixture and applying the plasma are repeated at least 10 times. Thus, the achieved coating and its colorimetric gas sensing properties can be easily observed by human eyes. However, it is also possible that further layers without gas sensing particles or compound are added, either on top of the gas sensing layer or between the single coatings of the gas sensing layer. In general, the polymer layers or polymer membranes, especially in the stack form, might not all comprise the gas sensing compounds or particles. As an example, polymer layers containing the gas sensing compounds or particles might be covered by additional polymer layers that could slow down the permeation of an analyte to the gas sensing compounds or particles. Such layers could also prevent direct contact between the gas sensing compounds or particles and food, for example.

According to other embodiments of the disclosure vapors of one or more polymer forming materials are added to the plasma process gas, so that larger layer thicknesses could be obtained. Thus, the gas sensing compound can be better protected from the environment.

In various implementations, a moving stage is adapted to move the substrate repeatedly or endlessly through both mentioned zones. Alternatively, the mentioned zones can be repeatedly passed over the substrate. For example, repeated sequences of depositing the mixture and applying the plasma are adapted to a production line. According to yet other embodiments of the disclosure, the substrate is exposed to a plasma afterglow region before entering the direct plasma discharge/zone. As explained in more detail below, such an afterglow region provides even more gentle plasma conditions and might prevent degradation of the gas sensing molecules or compound.

All the above mentioned features can be combined and/or substituted with each other.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 shows a schematic perspective view of an apparatus for forming a porous colorimetric gas sensing layer, in accordance with various embodiments of the present disclosure; and

FIG. 2 shows a spectral shift due to the presence of a gas sensed with a colorimetric gas sensing layer of the apparatus shown in FIG. 1, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

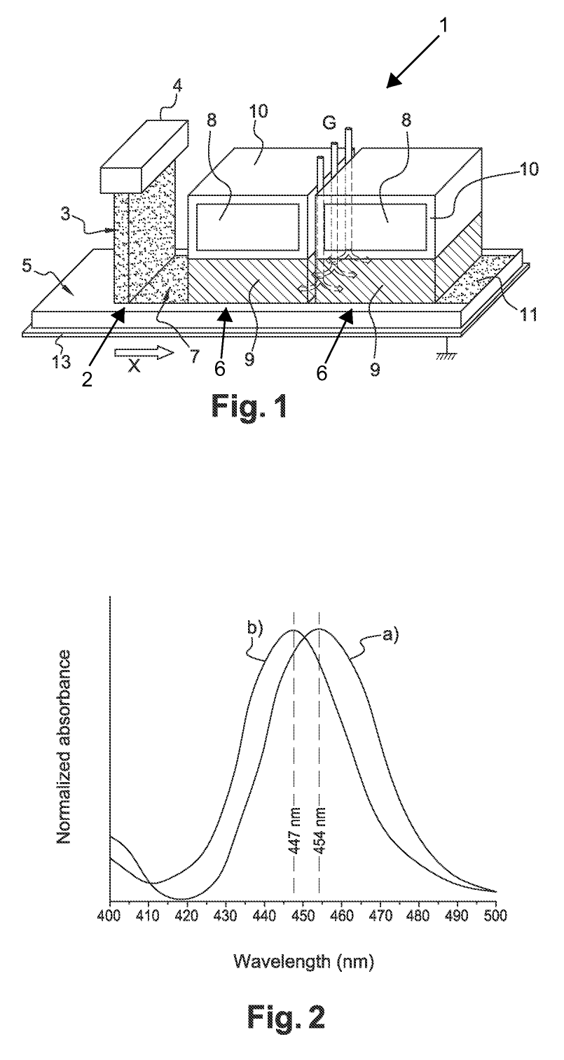

FIG. 1 shows a schematic view of an exemplary system 1 for forming a porous colorimetric gas sensing layer, in accordance with various embodiments of the present disclosure. According to FIG. 1, a mixture 3 of a solvent, gas sensing molecules, compound or particles and a polymer forming material is deposited, sprayed or vaporized via an atomizing nozzle 4 onto a portion 7 of a substrate 5. A stage 13 transports the substrate 5 in the X direction such that a portion 7 of the substrate 5 is moved through a mixture deposition zone 2 to deposit the mixture 3 on the portion of the substrate and a plasma zone 6 in which the coated substrate is exposed to an atmospheric pressure dielectric barrier discharge (AP-DBD) plasma 9. The zones 2 and 6 do not overlap, or are spatially distinct, respectively. The dielectric barrier discharge plasma 9 is provided via a system of two electrodes 8 arranged side by side and having a slot between them through which a gas G can pass to be directed in the direction of the coated substrate 5. Both electrodes 8 are coated with a dielectric layer 10. Being exposed to the dielectric barrier discharge plasma 9, the polymer forming material forms a polymer layer on the substrate 5. Having passed the plasma zone 9, the substrate 5 comprises a porous layer 11 including the gas sensing compound, molecules or particles. Although not depicted, the above mentioned steps should be carried out several times in order to obtain an effective gas sensing layer. Furthermore, the method is carried out at a specified atmospheric pressure, i.e. at pressures of about 10⁵ Pa.

In particular, it is possible that the moving stage 13 is arranged as a conveyor belt so that the substrate 5 can pass endlessly through the zones 2 and 6 of the system. Alternatively, the mentioned zones 2 and 6 could be adapted to repeatedly pass over the substrate 5. In various other embodiments, sequences of depositing the mixture and/or applying the plasma to a production line can be repeated. In various implementations, the plasma zone 6 can encompass the plasma region 6 and also their afterglow region. The afterglow region can be due to a distant plasma source or a pulsed plasma source.

In particular, if using an AP-DBD setup, as for example depicted in FIG. 1, an afterglow region is surrounding the plasma discharge 9 (not depicted as such). Hence, the deposited layer would be firstly exposed to the afterglow region, softer than the direct plasma discharge, and the membrane polymerization process is already starting in this region. Thus, the optical and/or chemical properties of the gas sensing molecules or compound can be further prevented from degradation. The (lateral) extension of an afterglow region could be for instance between 1% and 20% of the extension of the plasma zone 6.

Among the wide range of techniques used to grow smart composite films, AP-DBD is a new arising technology. Especially AP-DBD, which can generate low-temperature plasmas, offers the opportunity to work with heat-sensitive particles or substrates. In contrast with the limitations in industrial developments of low-pressure plasmas or sol-gel coatings, AP-DBD can be easily adapted on a coil-to-coil production line. Moreover, it is an environmentally friendly technology, which does not imply the use of solvent nor bath like in the wet methods or electrochemical depositions. However, in principle, other atmospheric pressure plasma techniques could be used, such as atmospheric pressure dielectric barrier discharge torch or DC and low frequency discharges or RF discharges or microwave induced plasmas.

The substrate 5 can be any kind of substrate. For example, the substrate 5 can comprise plastics, glass, or metal surfaces, e.g., the substrate 5 can be made of steel, copper, or aluminum. However, any material can be used as substrate 5, without any requirements related to its shape or thickness and dimension, because the discharge plasma apparatus can be adapted to cause coating deposition on a variety of different structures and shapes.

The gas sensing compound or particles can comprise one or more of pyrrole-based macrocycles, tetrapyrrols, porphyrins, metalloporphyrins, phthalocyanines, calixarenes, crystalline coordination polymers and compounds thereof.

Furthermore, organic solvents are necessary to obtain pores in the polymer layer, so that gas molecules to be detected can come into contact with the gas sensing molecules provided in the gas sensing layer.

In various implementations, the mixture 3 deposited or sprayed onto the substrate 5 can comprise solvents which are based on ethanol and/or chlorinated or chlorine based solvents. In particular, these compounds allow a good dispersion of the gas sensing compounds in the layers, particularly when applied together with porphyrins or metalloporphyrins, which tend to stick to each other and hide coordination sites. Moreover, these compounds have been identified as resulting in porous layer structures.

In various implementations, the polymer (matrix) forming material, or the precursor respectively, consists of an organosilicon based material or compound. For example, this material could be chosen from the group of hexamethyldisiloxane, octamethylcyclotetrasiloxane, decamethylcyclopentasiloxane, hexaethyldisiloxane, tetraethylorthosilicate, aminopropyltrimethoxysilane, tetramethyldisiloxane, pentamethylcyclopentasiloxane, octamethylcyclooctasiloxane, polydimethylsiloxane and its derivatives.

By depositing the above mentioned mixture 3 on the substrate 5 in a first step and afterwards applying the AP-DBD plasma 9 in a second (subsequent step), the gas sensing substances are protected by the surrounding polymer forming material and are less exposed to the direct plasma influence if compared with methods in which the substances are directly introduced into a plasma discharge. In particular, the deposited layer is firstly exposed to an afterglow region softer than the direct plasma discharge, and the membrane polymerization process starts therein. Furthermore, atomizing the mixture 3, results in a good spatial distribution of all mixture components forming the basis for a (homogenous) porous structure of the gas sensing layer.

### EXAMPLE 1

In one specific example according to the disclosure, a chromium 5,10,15,20-tetraphenylporphyrin (Cr(TPP)(Cl)(H₂O)) molecule to be embedded in the plasma-polymerized layers is first added to a mixture composed of 20 mL of hexamethyldisiloxane and 5 mL of dichloromethane. The prepared suspension is sprayed onto transparent polyethylene foils by an ultrasonic atomizing nozzle operating at 48 kHz and fed by a syringe driver. Polymerization of the deposited liquid layer is carried out with the AP-DBD depicted in FIG. 1. The discharge gap between the high voltage electrode and the substrate placed on the grounded electrode is maintained to 1 mm. Plasma is ignited by means of a 1,667 Hz modulated 10 kHz sinusoidal signal of 8 kV and fed by a gas mixture of N₂ and HMDSO. The operating discharge power density is maintained to 0.1 W cm ⁻². This example shall serve merely for illustrative purposes and must not be understood as limiting the scope of the present invention.

FIG. 2 depicts a UV-visible spectrum of the Cr(TPP)(Cl)(H₂O)/PDMS layer as deposited in accordance with Example 1 and after exposure to triethylamine. The obtained layer shows thus a shift of the absorbance maximum to a lower wave length which can be used as an indicator for the presence of the triethylamine gas. In particular, FIG. 2 depicts the normalized absorbance vs. the wavelength. Curve a) shows the absorbance in a triethylamine free atmosphere, whereas curve b) shows the characteristic absorbance of the layer sensing the triethylamine gas. This diagram merely serves for illustrative purposes as well and must not be understood as limiting.

### EXAMPLE 2

In another specific example according to the disclosure, a zinc 5,10,15,20-tetraphenylporphyrin (ZnTPP) molecule to be embedded in plasma-polymerized layers is first added to a mixture composed of 20 mL of hexamethyldisiloxane and 5 mL of isopropanol. The prepared suspension is sprayed onto transparent polyethylene foils by an ultrasonic atomizing nozzle operating at 48 kHz and fed by a syringe driver. Polymerization of the deposited liquid layer is carried out with an AP-DBD depicted in FIG. 1. The discharge gap between the high voltage electrode and the substrate placed on the grounded electrode is maintained to 1 mm. Plasma is ignited by means of a 1,667 Hz modulated 10 kHz sinusoidal signal of 8 kV and fed by a gas mixture of N₂ and HMDSO. The operating discharge power density is maintained to 0.2 W CM⁻². This example shall serve merely for illustrative purposes and must not be understood as limiting the scope of the present invention.

It is remarked that the features of the above described embodiments can be substituted with each other or combined in any suitable manner. Furthermore, the person skilled in the art can adapt these features in view of specific conditions, setups or applications.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. Method for forming a porous colorimetric gas sensing layer, said method comprising:
providing a mixture of an organic solvent, a polymer forming material and one of a gas sensing compound or gas sensing particles;
depositing the mixture on at least a surface portion of a substrate; and
applying an atmospheric pressure plasma to the surface portion to form a polymer layer comprising the one of the gas sensing compound and the gas sensing particles.

2. The method according to claim 1, further comprising repeating the steps of depositing the mixture on at least a surface portion of a substrate, and applying an atmospheric pressure plasma to the surface portion, multiple times to form a plurality of stacked polymer layers comprising the one of the gas sensing compound and the gas sensing particles.

3. The method according to claim 1, wherein the one of the gas sensing compound and the gas sensing particles comprise an indicator dye and one or more of pyrrole-based macrocycles, tetrapyrrols, porphyrins, metalloporphyrins, phthalocyanines, calixarenes, crystalline coordination polymers and compounds thereof.

4. The method according to claim 2, wherein the polymer forming material is based on organosilicon compounds.

5. The method according to claim 4, wherein the polymer forming material comprises one of hexamethyldisiloxane, octamethylcyclotetrasiloxane, decamethylcyclopentasiloxane, hexaethyldisiloxane, tetraethylorthosilicate, aminopropyltrimethoxysilane, tetramethyldisiloxane, pentamethylcyclopentasiloxane, octamethylcyclooctasiloxane, polydimethylsiloxane and its derivatives.

6. The method according to claim 5, wherein the organic solvent is chosen from non-polar solvents, polar aprotic solvents, or polar protic solvents.

7. The method according to claim 6, wherein the organic solvent comprises one or more of ethanol, methanol, isopropanol, chloroform, dichloromethane, tetrahydrofuran, and aceton solvents.

8. The method according to claim 7, wherein applying the atmospheric pressure plasma is carried out between a temperature of 5° C. and 90° C.

9. The method according to claim 8, wherein the substrate comprises one of glass, plastic, composite materials and metals.

10. The method according to claim 9, wherein an oxygen content in the plasma process gas is lower than 500 ppm.

11. The method according to claim 10, wherein vapors of one or more polymer forming materials are added to the plasma process gas.

12. The method according to claim 12, wherein depositing the mixture is controlled by means of an atomizing nozzle.

13. The method according to claim 12, wherein steps of providing a mixture of an organic solvent, a polymer forming material and one of a gas sensing compound or gas sensing particles, and depositing the mixture on at least a surface portion of a substrate, are repeated ten or more times.

14. The method according to claim 13, wherein the substrate is provided on a moving stage transporting the substrate through a mixture deposition zone to deposit the mixture on at least a portion of the substrate and a plasma zone in which the atmospheric pressure plasma is applied.

15. The method according to claim 14, wherein the moving stage is adapted to move the substrate repeatedly through the zones.

16. The method according to claim 15, wherein the substrate is exposed to a plasma afterglow region before entering the direct plasma application.
